(19) United States
(12) Patent Application Publication
(10) Pub. No.: US 2026/0316507 A1
(43) Pub. Date: Oct. 15, 2026

(54) DAMPING VALVE DEVICE FOR A VIBRATION DAMPER

(71) Applicants: thyssenkrupp Bilstein GmbH, Ennepetal (DE); thyssenkrupp AG, Essen (DE)

(72) Inventors: Freddy WOENARTA, Braunschweig (DE); Nicolas SUMKOETTER, Wadersloh (DE)

(73) Assignees: thyssenkrupp Bilstein GmbH, Ennepetal (DE); thyssenkrupp AG, Essen (DE)

(21) Appl. No.: 18/998,626

(22) PCT Filed: Jul. 19, 2023
(86) PCT No.: PCT/EP2023/070022

§ 371 Date: Jan. 27, 2025

(30) Foreign Application Priority Data
Jul. 27, 2022 (DE) 10 2022 207 698.2
Jul. 27, 2022 (LU) LU 102988

(51) Int. Cl. B60G 17/015; B60G 13/08; B60G 17/0165; B60G 17/08

(52) U.S. Cl. CPC B60G 17/0152; B60G 13/08; B60G 17/0165; B60G 17/08; B60G 2202/24; B60G 2204/62; B60G 2206/41; B60G 2500/104; B60G 2500/114; B60G 2600/182; B60G 2800/162; B60G 2800/916

(57) ABSTRACT

A damping valve device for a hydraulic vibration damper for a vehicle comprises a drive region and a valve region, and a damping valve housing having a tube part which encloses the drive region and the valve region, wherein the drive region has a coil which is designed in such a manner that it generates a magnetic circuit within the damping valve device and interacts with an armature that is attached so as to be axially movable within the coil, in order to move the armature in the axial direction, wherein the armature is disposed within a pole tube, and the pole tube forms a guide of the armature, wherein the valve region has a fluid inlet and a fluid outlet for letting a hydraulic fluid into and out of the valve region, and a valve block having a plurality of flow passages for conducting the hydraulic fluid, wherein the valve region has a control slide which is attached so as to be movable relative to the valve block in such a manner that it is movable between a closed position in which the flow passages are closed by the control slide and an opened position in which the flow passages are free, wherein at least two flow passages are disposed at different height levels.

The invention relates to a damping valve device for a vibration damper, in particular for motor vehicles.

Vibration dampers, in particular shock absorbers, are commonly used in motor vehicles and are mounted between a wheel suspension, in particular an axle, and the body of the vehicle in order to dampen shocks and reduce vibrations while driving. To increase driving comfort and safety, the damping characteristics of the vibration damper are usually adjustable. For example, this is done via a solenoid valve, via which the flow of the hydraulic fluid within the vibration damper is adjustable, thus facilitating or impeding the movement of the piston of the vibration damper.

For example, solenoid valves are disposed on the outside of the vibration damper tube and thus represent a module which is separate from the vibration damper tube and occupies additional installation space within the vehicle.

Known from EP2685145A2 is a damping valve device which is attached to the outside of the vibration damper.

Proceeding therefrom, it is an object of the present invention to reduce the manufacturing costs, in particular the number and complexity of the components, the assembly time, as well as the weight of a damping valve device of a vibration damper.

This object is achieved according to the invention by a damping valve device having the features of independent device claim 1. Advantageous refinements are derived from the dependent claims.

According to a first aspect of the invention, a damping valve device for a hydraulic vibration damper for a vehicle, in particular a motor vehicle, comprises a drive region and a valve region. The damping valve device furthermore comprises a damper valve housing having a tube part which encloses the drive region and the valve region, wherein the drive region has a coil which is formed in such a manner that it generates a magnetic circuit within the damping valve device and interacts with an armature that is attached so as to be axially movable within the coil, in order to move the armature in the axial direction. The armature is disposed within a pole tube, wherein the pole tube forms a guide of the armature. In particular, the pole tube forms an axial guide for guiding the movement of the armature in the axial direction. The valve region has a fluid inlet and a fluid outlet for letting a hydraulic fluid into and out of the valve region, and a valve block having a plurality of flow passages for conducting the hydraulic fluid. The valve region has a control slide which is attached so as to be movable relative to the valve block in such a manner that it is movable between a closed position in which the flow passages are closed by the control slide and an opened position in which the flow passages are free. At least two flow passages are disposed at different height levels, wherein preferably at least one flow duct is disposed so as to be offset with respect to the flow passages.

The disposal of the flow passages at different height levels causes the flow passages to be opened/closed by the control slide in a predetermined sequence. This enables an optimal distribution of the transverse force acting on the control slide during the switching procedure.

For example, the valve block has a first cylindrical region, in which the flow passages are formed. The first region is preferably adjoined in the direction of the fluid outlet by a second substantially cylindrical region which is coaxial with the first region and has a larger diameter relative to the first region. The second region has, by way of example, a radially outward-pointing circumferential face, and a shoulder face which points axially in the direction of the first region. The shoulder face preferably lies against the pole tube. The first region of the valve block preferably has the flow passages and is in particular disposed so as to be coaxial with the control slide. The first region is preferably able to be completely or partially enclosed by the control slide. The flow passages are preferably circular bores in the valve block, in particular the wall of the first region of the valve block. Preferably, the flow passages are disposed so as to be uniformly spaced apart from one another in the circumferential direction of the first region of the valve block. For example, at least two directly adjacent flow passages are disposed at respective different height levels. In particular, all flow passages are disposed at respective different height levels.

The height level is preferably understood to mean the spacing of the center of the respective flow passage from a specific cross-sectional plane of the damping valve device. This is understood to mean in particular the axial spacing of the center of the respective flow passage from the shoulder face of the second region of the valve block.

According to a first embodiment, at least two flow passages are disposed at the same height level. Simultaneous opening of the flow passages by means of the control slide is achieved as a result, and the distribution of the forces acting on the control slide in the switching procedure of the damping valve is optimized.

According to a further embodiment, flow passages which are circumferentially opposite one another on the valve block are disposed at the same height level. Preferably, the valve block has four, six, eight or ten flow passages which are disposed circumferentially about the first region of the valve block, and wherein in particular respective adjacent flow passages are disposed so as to be mutually offset by an angle of 90°, 60°, 45° or 36° about the central axis of the valve block. Mutually opposite flow passages are disposed so as to be mutually offset by 180° Simultaneous opening/closing of opposite flow passages optimizes the distribution of the forces acting on the control slide in the switching procedure of the damping valve. Alternatively, flow passages which are circumferentially opposite one another on the valve block are disposed at different height levels.

According to a further embodiment, flow passages which are circumferentially opposite one another on the valve block have a height level difference that is less than the height level difference in relation to the respective directly adjacent flow passages. This results in mutually opposite flow passages opening/closing immediately one after the other.

According to a further embodiment, at least two flow passages have different diameters. According to a further embodiment, at least two flow passages have different geometries. Preferably, all flow passages have different diameters and/or geometries. This enables an optimal adjustment of the forces acting on the control slide in the switching procedure of the damping valve.

According to a further embodiment, a plurality of flow ducts which extend at least partially in the radial direction are formed between the pole tube and the valve block. The flow ducts are preferably formed in the second region of the valve block and are in particular formed so as to be open in the direction of the pole tube in such a way that the flow ducts are in each case formed between the internal face of the pole tube and the radially outward-pointing face of the valve block. The flow ducts preferably extend from the shoulder face to the circumferential face and in particular represent clearances, preferably convexities, in the shoulder face and the circumferential face. The direction of extent of the flow ducts preferably has an axial and a radial component. For example, the flow ducts extend continuously at an angle of 10° to 80°, in particular 20° to 60°, preferably 30° to 50°, in relation to the axial direction. For example, the flow ducts are formed as half-shell shapes in the valve block and extend in particular in a star shaped manner away from the first region, in particular from the flow passages.

According to a further embodiment, at least one flow duct is disposed so as to be co-aligned with one of the flow passages. Preferably, each flow duct is disposed so as to be co-aligned with a respective flow passage. An optimal flow of the damping fluid is achieved as a result. Preferably, the number of flow passages corresponds to the number of flow ducts. Preferably, the flow ducts are disposed at the same height with at least one flow passage. It is also conceivable that more flow ducts are provided than flow passages. For example, at least one flow duct is disposed so as to be offset with respect to the flow passages. It is also conceivable that all flow ducts are disposed so as to be offset with respect to the flow passages.

In the text below, the axial direction is to be understood as the direction parallel to the axial centerline of the damping valve device, in particular of the tube part of the damping valve device. The radial direction is understood to be the direction orthogonal to the axial direction.

The hydraulic vibration damper preferably comprises an inner cylinder tube and an outer cylinder tube which is disposed so as to be coaxial with the latter and in particular forms the external wall of the vibration damper. Within the inner cylinder tube, a piston is preferably attached so as to be axially movable on a piston rod, dividing the inner cylinder tube into two working spaces. In particular, the piston has at least two fluid feedthroughs by way of which one working space is connected to the other working space. Formed between the inner and the outer cylinder tube is preferably an annular space, wherein a central tube, which divides the annular space, is preferably attached within the annular space, so as to be coaxial between the inner and the outer cylinder tube. The damping valve device is preferably fluidically connected to at least one of the working spaces of the inner cylinder tube, and preferably attached to the central tube and the outer cylinder tube of the vibration damper. The vibration damper is preferably filled completely or partially with a hydraulic fluid.

The tube part is preferably designed in such a manner that it is able to be connected to the outer cylinder tube and in particular has a substantially constant circular cross section. The tube part preferably forms the outer housing wall of the damping valve device. In particular, the drive region and the valve region are disposed completely within the tube part, so that the tube part preferably extends in the axial direction beyond the drive region and/or the valve region. The valve region is preferably disposed in a region of the tube part facing the outer cylinder tube of the vibration damper, wherein the drive region is disposed in the opposite region of the tube part that faces away from the outer cylinder tube of the vibration damper. The tube part is preferably made of a magnetic or magnetizable material.

The drive region preferably comprises a solenoid, wherein the solenoid comprises a coil having a plurality of windings which are disposed on a coil carrier, for example. The coil carrier is preferably formed from a plastics material and in particular designed so as to be substantially hollow-cylindrical and disposed so as to be coaxial with the tube part.

The coil is preferably fixedly connected to the tube part, in particular in a materially integral, form-fitting and/or force-fitting manner. For example, a clearance fit is formed between the pole tube and the coil. The coil is preferably designed and disposed in such a manner that it generates a magnetic circuit within the damping valve device. Preferably, the coil impinged with an electrical current generates a magnetic flux which runs in a closed path within the damping valve device. The magnetic circuit comprises the elements of the damping valve device through which the magnetic flux generated by the coil passes in a closed path.

The armature is disposed within the coil, preferably so as to be coaxial with the latter. The armature is preferably formed from a magnetic or magnetizable material, and is in particular part of the magnetic circuit. Preferably, the armature has a first cylindrical region which in the axial direction is adjoined by a second cylindrical region having a smaller diameter relative to the first region. Disposed in particular between the armature and the coil is the pole tube which is at least partially hollow cylindrical and extends so as to be coaxial with the coil, the tube part and the armature. The pole tube is preferably formed from a magnetic or magnetizable material, and is in particular part of the magnetic circuit. For example, the armature is at least partially or completely wrapped with a sliding film, such as a PTFE film, as a result of which the axial movement of the armature within the pole tube is facilitated. The pole tube preferably has a hollow-cylindrical region which preferably has a substantially constant cross section and lies at least partially against the coil, in particular the coil carrier. In particular, the hollow-cylindrical region has a substantially constant internal and/or external diameter, in particular a constant wall thickness.

The hollow-cylindrical region preferably forms the guide, in particular axial guide, of the armature, so that the armature is attached so as to be movable in the axial direction within the pole tube. The hollow-cylindrical region of the pole tube preferably extends in the axial direction, preferably in the direction of the housing upper part, beyond the coil and in particular has on its end a base which completely closes the pole tube on the end side. A cylindrical armature space in which the armature and hydraulic fluid are disposed is preferably formed within the hollow-cylindrical region. The hollow-cylindrical region of the pole tube is adjoined in the axial direction by a valve-proximal region which points toward the valve region and has at least one or a plurality of enlargements of the internal diameter and/or of the external diameter. The valve-proximal region of the pole tube is preferably designed to be funnel-shaped, wherein the funnel widens in the direction of the valve. The pole tube, in particular the valve-proximal region of the pole tube, is preferably fixedly connected to the tube part, in particular in a form-fitting, force-fitting and/or materially integral manner. For example, the pole tube extends in the axial direction at least partially or completely along the coil, the valve slide and the valve block.

The pole tube, in particular the valve-proximal region, preferably encloses, in particular circumferentially, the valve block and/or the control slide. Preferably, an annular space filled with hydraulic fluid is formed between the valve block and/or the control slide and the pole tube. The control slide is preferably attached so as to be movable relative to the valve block and the pole tube in the axial direction, and disposed so as to be coaxial with the tube part and the pole tube. The control slide is preferably operatively connected to the armature, so that the movement of the armature is at least partially or completely coupled to the control slide. The control slide preferably has an axial end face which points in the direction of the armature and against which the armature lies in such a way that a movement of the armature is transmitted to the control slide.

The valve block is preferably disposed so as to be coaxial with the pole tube, and in particular has a cavity which is fluidically connected to the fluid inlet/fluid outlet so that hydraulic fluid flows into the valve block. A fluid space in which the hydraulic fluid is able to flow is preferably formed between the valve block and the pole tube. The valve block is designed to be funnel-shaped, for example, and has, for example, a cylindrical region which faces the drive unit and is disposed so as to be coaxial with the control slide, and preferably has a substantially constant cross section. The control slide preferably encloses the valve block circumferentially and is mounted so as to be movable in the axial direction relative to the valve block. On the region facing away from the drive unit, the valve block has for example a funnel-shaped radial enlargement. The valve block is attached in particular so as to be stationary relative to the axially movable control slide and is, for example, fixedly connected to the pole tube. Preferably, the valve block is circumferentially and in the axial direction at least partially or completely enclosed by the pole tube element, wherein the control slide is disposed between the drive-proximal region of the valve block and the pole tube element.

Flow passages, in particular passage openings, by way of which the hydraulic fluid is able to flow, in particular from the fluid inlet to the fluid outlet, are preferably formed within the valve block. The flow passages are preferably disposed in the cylindrical region of the valve block that is enclosed by the control slide. The control slide is attached so as to be axially movable in such a manner that it completely releases the flow passages in an opened position of the damping valve device, and completely closes the flow passages in a closed position of the damping valve device. The control slide is mounted in such a manner that it is preferably movable to a plurality of intermediate positions in which the flow passages are partially closed. The control slide is preferably preloaded in the direction of the opened position by means of a spring. The spring is preferably disposed between the control slide and the valve block and impinges the control slide preferably with a force acting axially in the direction of the drive region.

The pole tube is preferably designed in one piece. “In one piece” is preferably understood to mean designed from one piece, in particular a solid block, wherein “in one part” includes a fixed connection between a plurality of parts, for example by means of a form-fit, a force-fit and/or a materially integral connection. A pole tube designed in one piece or one part considerably simplifies the assembling of the damping valve device. It is no longer necessary to assemble the pole tube in a complex manner. In addition, fastening means for assembling a multi-part pole tube are dispensed with, which results in a weight saving. A further weight saving is achieved in that the tube part is part of the magnetic circuit, since in this way at least a part of the coil carrier, in particular the outer casing, can be dispensed with. For example, the pole tube is produced by a subtractive machining process, in particular turning or milling. In particular, the pole tube is manufactured by casting or cold forming.

The damping valve device has, for example, a sealing element which is disposed in a chamber, wherein the chamber is formed between the pole tube and the tube part and additionally the coil and/or a support ring. The chamber is preferably closed by the pole tube and the tube part, as well as additionally the coil and/or the support element. The chamber is preferably designed for receiving a sealing element, in particular a sealing ring. Preferably, the chamber is designed in annular shape, and in particular has a rectangular cross section. In particular, the chamber is completely closed and delimited by the pole tube, the tube part and the coil and/or the support ring. A sealing element, which is preferably a sealing ring, is attached in the chamber. Preferably, the sealing element lies at least against the pole tube and the tube part, and serves in particular for the sealing so that no hydraulic fluid from the valve region enters the coil. In particular, the sealing element lies additionally against a step of the pole tube.

A chamber formed between the pole tube and the tube part and additionally the coil and/or a support ring to accommodate the sealing element enables easy assembling of the sealing element on the pole tube. In particular, damage to a sealing element designed as a sealing ring is avoided, as the latter can be assembled largely in a non-tensioned state.

For example, the sealing element is designed as an O-ring. Preferably, the sealing element is made of a plastics material, in particular an elastomer. The sealing element is in particular designed so as to be annular and preferably has a round, in particular circular, cross section. Preferably, the cross-sectional diameter of the sealing ring is larger than the cross-sectional width of the chamber, so that it preferably abuts at least three internal faces of the chamber.

In particular, the pole tube has a radial step adjacent to the chamber. Preferably, the radial step represents a radial enlargement of the pole tube relative to a region of the pole tube directly adjacent in the direction of the housing upper part. Preferably, the pole tube has a plurality of different external diameters, wherein the external diameter of the pole tube decreases in particular from the chamber in the direction of the housing upper part. The external diameter of the pole tube within the chamber is preferably greater than or equal to the external diameter of the region of the pole tube extending from the chamber in the direction of the housing upper part. This makes it easier to push the sealing ring onto the pole tube.

In the axial direction from the drive region in the direction of the valve region, the pole tube preferably has a first external diameter, which is disposed within the coil. This is adjoined, for example, by a second external diameter which is larger than the first external diameter, so that a step, in particular an axial end face, is formed, which faces in the direction of the housing upper part and against which the coil preferably at least partially lies The second external diameter is preferably spaced apart from the internal diameter of the tube part in such a manner that the chamber is formed between the pole tube and the tube part. The second external diameter is preferably adjoined by a third external diameter of the pole tube, which is larger than the first and second external diameter and preferably substantially corresponds to the internal diameter of the tube part, so that the pole tube with the third external diameter lies against the tube part. Formed between the second and the third external diameter is preferably an axial end face which points in the direction of the housing upper part and delimits the chamber.

For example, the coil has a projection which extends in the axial direction and is adjacent to the chamber. Preferably, the coil has a receptacle to which the windings and the coil carrier are fixedly connected. In particular, the receptacle is formed of a plastics material which is preferably applied at least partially or completely about the windings and the coil carrier by means of injection molding. Preferably, the plastics material is injected onto the windings and the coil carrier. Preferably, the receptacle forms the shell face of the coil pointing in the direction of the tube part, and lies in particular against the tube part. For example, the receptacle is formed in one part or one piece with the housing upper part. Preferably, the receptacle is connected to the tube part by way of a clearance fit, or is fixedly connected, in particular in a force-fitting, materially integral and/or form-fitting manner. The coil preferably has a projection which runs in the axial direction, in particular along the inner wall of the tube part and extends between the tube part and the pole part and is adjacent to the chamber. The projection is preferably formed from a plastics material. The projection is preferably formed in the receptacle or the coil carrier of the coil. The end face of the projection pointing in the valve direction preferably forms a delimitation of the chamber. Preferably, the pole tube and the tube part are connected to one other by way of a form-fitting connection, in particular by a bayonet closure. The form-fitting connection, for example, has at least one axial recess formed in the pole tube, which opens into the chamber. The form-fitting connection is in particular a bayonet connection. For example, the pole tube has a plurality of clearances, which are in particular designed to be hook-shaped. Each clearance comprises, for example, a region which extends in particular in the axial direction and, adjoining thereto, a region extending in the radial direction. In each case, a radial constriction of the tube part preferably engages in the clearance. The clearances are preferably radial depressions which are formed in the outer surface of the pole tube that lies against the tube part. Preferably, the clearances extend into the chamber and form in particular interruptions of the contact face of the sealing element. In this case, the sealing element 13 preferably has depressions and projections, wherein the projections engage in the clearances of the pole tube 7 and form, for example, a form-fitting connection.

The damping valve device has, for example, a support ring disposed separately from the coil. Preferably, the support ring, by way of an external face, lies at least partially against the coil.

The support ring is preferably designed in an annular shape and, by way of example, has a rectangular cross section. In particular, the support ring 15, by way of its external face, lies against the inside of the tube part, and, by way of its internal face, lies against the external face of the pole tube. The end face of the support ring pointing in the direction of the valve is in particular adjacent to the chamber. The support ring is preferably fixedly connected to the coil, the pole tube and/or the tube part. Preferably, the support ring forms a contact face for the sealing element. For example, the projection of the coil is provided as an alternative to, or conjointly with, the support ring.

For example, the pole tube has a hollow-cylindrical region which is disposed within the coil, and wherein the hollow-cylindrical region has a recess which extends in the circumferential direction. The recess is preferably formed between the coil and the armature in the pole tube and, for example, designed in an annular shape. Preferably, the recess extends in the circumferential direction of the pole tube as a completely closed ring about the pole tube, or has interruptions. In particular, the recess extends in the radial direction from the outside to the inside into the pole tube. The depth of the recess is preferably smaller than the wall thickness of the pole tube, so that the recess does not form an opening. In particular, the recess is completely or partially filled with a material, in particular a magnetically insulating material, such as plastics material. For example, the recess is completely or partially filled with ambient air. The recess preferably has a cross section with a valve-proximal region which widens in the radial direction from the inside to the outside in the direction of the valve region. The pole tube preferably has a conical region in the region of the recess, which serves to introduce the magnetic flux into the armature. In the direction of the housing upper part, a region with a rectangular, in particular square, cross section adjoins the valve-proximal region of the recess, for example.

The coil is preferably fixed in the axial direction by way of the recess. The receptacle of the coil preferably has a radially inward-pointing projection which engages in the recess of the pole tube and in particular has a shape which corresponds to the cross section of the recess, so that a form-fitting connection between the receptacle and the pole tube is formed.

In particular, the tube part is designed in one part or one piece. The tube part is preferably formed from one piece, for example cast and machined in particular by means of subtractive methods such as turning, laser-machining or milling. For example, the tube part is produced by cold forming.

Preferably, the tube part extends in the axial direction beyond the coil and the valve block. The tube part, conjointly with the housing upper part, preferably forms the external wall of the damping valve device. Preferably, the damping valve housing consists of the housing upper part and of the tube part. The tube part is preferably connected directly to the housing upper part and the outer cylinder tube of the vibration damper.

For example, the tube part is connected to the pole tube in a form-fitting, force-fitting and/or materially integral manner. Preferably, the pole tube, in particular in the valve-proximal region, has a circumferential recess which interacts with a constriction of the tube part so as to form a form-fitting connection.

For example, the pole tube is designed in one part and/or one piece and surrounds the armature and the control slide. According to a further embodiment, the pole tube extends in the axial direction beyond the valve block. The valve block and the control slide are preferably completely enclosed circumferentially and in the axial direction by the pole tube.

Preferably, the damping valve device has a flux plate made of a magnetic or magnetizable material, wherein the flux plate lies against the coil, the pole tube and/or the tube part. The flux plate is preferably attached to the end side of the coil that faces away from the valve region, and extends in particular about the armature.

In particular, the magnetic circuit is formed from the coil, the pole tube, the tube part, the armature and the flux plate. The elements of the magnetic circuit are preferably formed completely or partially from a magnetic or magnetizable material. In particular, adjacent elements of the magnetic circuit lie directly against one another in order to ensure a magnetic flux that is as resistance-free as possible.

For example, the flux plate is designed in the shape of an annular disc and has, for example, at least one radial clearance. For example, the flux plate has a plurality of clearances which point radially from the outside to the inside and are in particular uniformly spaced apart from one another. Preferably, the clearances extend radially into the flux plate by approximately one third to half the radius of the latter.

According to a further embodiment, the damping valve housing has a housing upper part which is attached to the end face of one end of the tube part, wherein the pole tube extends from the housing upper part to the valve block. Disposed in the housing upper part is preferably a plug contact for a current connection of the coil, and in particular electrical lines leading from the plug contact to the coil, such as conductor tracks, sheet-metal strips or copper strips. The housing upper part preferably forms a cover of the tube part.

For example, the pole tube is connected to the valve block by means of a mechanical joining connection. A mechanical joining connection is preferably understood to mean a connection of two components by means of forming, wherein at least one of the components is mechanically formed. Connecting the pole tube to the valve block by forming the pole tube and/or the valve block enables easy pre-assembling of the pole tube on the valve block, so that the former can be inserted into and connected to the tube part together with the valve block. This significantly reduces assembly time and costs.

The mechanical joining connection comprises, for example, a plastic deformation of the pole tube, such as crimping and/or bead-rolling of the pole tube. The end region of the pole tube is preferably mechanically formed, so as to form the mechanical joining connection between the pole tube and the valve block. In particular, a preloading element, for example a spring disc or a plate spring, is disposed between the pole tube and the valve block. The preloading element is designed in particular in such a manner that it impinges the pole tube with an axial spring force and preferably preloads said pole tube in relation to the valve block. For example, the pole tube has a forming edge, which is produced by means of plastic deformation of the pole tube, whereby the preloading element lies against the latter. Preferably, the preloading element lies against the valve block, in particular the comfort valve body.

The invention also comprises a vibration damper for a vehicle, having a damping valve device as described above, wherein the vibration damper has an outer cylinder tube, and wherein the tube part of the damping valve device is connected, in particular directly, to the cylinder tube. Preferably, the cylinder tube is connected to the tube part in a form-fitting, force-fitting and/or materially integral manner. In particular, the cylinder tube is connected to the tube part by way of a fastening means. A comfort valve, which is in particular hydraulically connected in series to the damping valve device described above, is preferably disposed in the tube part.

### DESCRIPTION OF THE DRAWINGS

The invention is explained in more detail hereunder by means of a plurality of exemplary embodiments with reference to the appended figures, in which:

FIG. 1 shows a schematic illustration of a vibration damper having a damping valve device according to one exemplary embodiment, in a lateral view;

FIG. 2 shows a schematic illustration of a damping valve device according to one exemplary embodiment, in a sectional view;

FIG. 3 shows three schematic illustrations in each case of a valve block according to further exemplary embodiments, in a perspective view; and

FIG. 4 shows two schematic illustrations in each case of a disposal of the flow passages in a valve block according to further exemplary embodiments, in a perspective view.

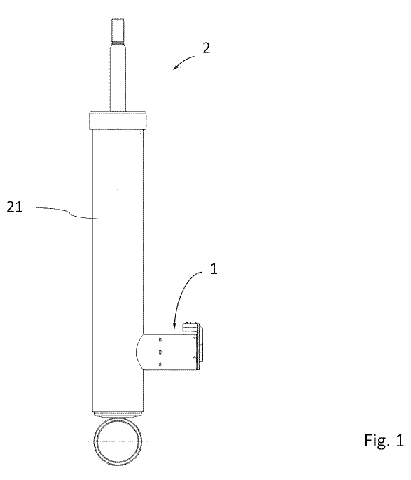

FIG. 1 shows a vibration damper 2 for a vehicle chassis, wherein the vibration damper 2 comprises a damping valve device 1. The vibration damper 2 of FIG. 1 is shown only in an exterior view. The vibration damper 2 preferably comprises a cylinder tube which has a hydraulic fluid that is received in a sealed manner therein, a piston which is axially movable within the cylinder tube along a cylinder tube axis and which divides the cylinder tube into two working spaces, and a piston rod which is aligned parallel to the cylinder tube axis and is connected to the piston. In particular, the piston has at least two fluid feedthroughs by way of which one working space is connected to the other working space. The vibration damper 2 is a multitube vibration damper, for example. In particular, the vibration damper 2 has an inner cylinder tube in which the piston is guided. For example, the outer cylinder tube 21 is attached coaxially about the inner cylinder tube, wherein an annular space is formed between the inner and the outer cylinder tube 21. A central tube, which divides the annular space, is preferably attached between the inner and the outer cylinder tube 21, so as to be coaxial therewith. For damping the piston movement in at least one, preferably both, operating direction(s), a damping valve device 1 is connected to at least one of the working spaces. The damping valve device 1 is preferably attached to the central tube and the outer cylinder tube 21 of the vibration damper 2.

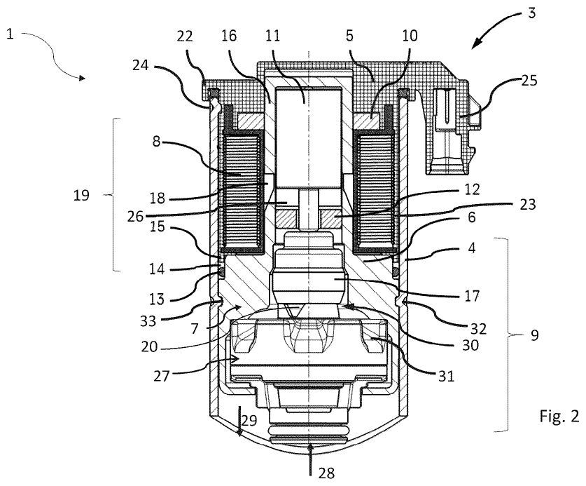

FIG. 2 shows a damping valve device 1 having a preferably cylindrical damping valve housing 3 which comprises a substantially tubular tube part 4, and a housing upper part 5 attached to the tube part 4. The tube part 4, by way of one of its ends, is connected with the cylinder tube 21 (not shown in FIG. 2) of the vibration damper 2. At the other end of the tube part 4, opposite to the cylinder tube 21, the housing upper part 5 is attached in such a way that the housing upper part 5 preferably closes the tube part 4 on the end side. The housing upper part 5 has, for example, a circular-cylindrical cover portion 22 which has a larger diameter than the tube part 4 and protrudes radially beyond the tube part 4. The cover portion 22 is adjoined by a hollow cylinder portion 23 which has a smaller diameter than the tube part 4, in particular than the internal diameter of the tube part 4, and is disposed coaxially therewith within the tube part 4. The housing upper part 5, in particular the hollow cylinder portion 23, preferably lies against the inner wall of the tube part 4. By way of example, the cover portion has an annular clearance at the side facing in the direction of the tube part 4, in which the end of the tube part 4 is received. By way of example, the tube part 4 is connected to the housing upper part 5 by way of a form-fitting connection 24. By way of example, the form-fitting connection 24 is formed by a radial clearance in the housing upper part 5, in which a radial restriction of the tube part 4 engages.

The form-fitting connection 24 is preferably formed on that end of the tube part 4 that faces the housing upper part 5. The housing upper part 5, in particular the cover portion 22, has a connecting region 25 which has one or a plurality of connection contacts for an electrical power supply of the damping valve device 1. Preferably, the connection contacts for an electrical power supply are connected to a drive unit 19.

By way of example, the damping valve device 1 has a drive region 19 and a valve region 9. By way of example, the drive region 19 is disposed in the upper region of the damping valve device 1 that faces the housing upper part 5, and is preferably disposed substantially above the valve region 9. The drive region 19 preferably comprises a drive designed as a solenoid. The solenoid comprises a coil 8 with a plurality of windings made from a current-conducting wire. The coil 8 is preferably disposed within the tube part 4 and disposed so as to be concentric with the latter. By way of example, the coil 8 is disposed within the hollow cylinder portion 23 of the housing upper part 5 and lies in particular against the inner wall of the housing upper part 5. In particular, the coil 8 is cast into the housing upper part 5, wherein the housing upper part 5 is formed, for example, from a plastics material, in particular a material which is not or only very slightly magnetic, preferably a magnetic isolator or a material with a high magnetic resistance. For example, the coil comprises a coil carrier on which the windings of the coil are wound. The coil 8 encloses at least partially or completely an armature space 26 which extends centrally in the axial direction and concentrically with the tube part 4. An armature 11 is mounted so as to be axially movable within the armature space 26. The armature 11 is preferably of a cylindrical design and has a diameter that is slightly smaller than the diameter of the armature space 26, so that the armature 11 is preferably attached so as to be able to slide in the axial direction. By way of example, the armature 11 has an upper, first cylindrical region which faces the housing upper part 5 and which is adjoined on the valve region side by a second cylindrical region that is disposed so as to be coaxial with the first region and has a smaller diameter. The armature space 11 is preferably delimited by a hollow cylinder 16, which is disposed so as to be coaxial with the tube part 4 and within the latter. The hollow cylinder 16 preferably has a base and is in particular designed to be in the direction of the cylinder tube 21. The base preferably points in the direction of the housing upper part 5 and lies at least partially against the latter, for example. The hollow cylinder 16 is preferably formed from a magnetizable or magnetic material.

The coil 8 is preferably designed and disposed in such a manner that said coil 8 when energized forms a magnetic field with magnetic field lines which preferably run substantially in the axial direction in the armature space 26. The armature 11 is preferably formed from a magnetizable or magnetic material and movable in the axial direction, in a manner corresponding to the polarity of the magnetic field formed by means of the coil 8. Disposed within the armature space 26 is in particular a pole part 12 which is designed to be hollow-cylindrical and is disposed so as to be coaxial with the tube part 4. The armature 11, in particular the second cylindrical region of the armature 11, extends in the axial direction centrically through the pole part 12. The pole part 12 is preferably formed from a magnetizable or magnetic material. The pole part 12 lies in particular against the internal wall of the hollow cylinder 16 and is, for example, fixedly connected to the latter. Formed between the pole part 12 and the armature 11 is preferably an annular space through which a flow of hydraulic fluid is in particular able to pass.

A flux plate 10 is disposed circumferentially about the hollow cylinder 16 and concentrically with the latter. The flux plate 10 is preferably designed to be hollow-cylindrical and lies in particular against the external wall of the hollow cylinder 16. Furthermore, the flux plate 10 lies at least partially against the tube part 4 and preferably represents a magnetic flux connection between the hollow cylinder 16 and the tube part 4. Preferably, the flux plate 10 lies against the coil 8 and in particular represents a magnetic flux connection between the hollow cylinder 16, the tube part 4 and/or the coil 8. By way of example, the flux plate 10 has at least two mutually opposite clearances which extend in the radial direction from the outside to the inside, the section of the illustration of FIG. 2 running through said clearances.

A pole tube element 6 adjoins the hollow cylinder 16 in the axial direction, so as to be coaxial therewith. The pole tube element 6 and the hollow cylinder 16 conjointly form the pole tube 7, wherein the pole tube 7 is formed in particular in one piece or one part. Preferably, the pole tube element 6 is formed in one part with the hollow cylinder 16, or is fixedly connected to the latter, for example in a form-fitting, force-fitting and/or materially integral manner. The hollow cylinder 16 extends in the axial direction at least partially or completely along the coil 8. Preferably, the pole tube element 6, conjointly with the hollow cylinder 16, encloses at least the armature 11, the armature space 26 and the pole part 12.

The pole tube 7 has an upper tubular region with in particular a constant internal diameter which preferably comprises the hollow cylinder 16 and extends from the housing upper part in the axial direction beyond the armature 11. The upper tubular region is adjoined in the axial direction by a lower region with an enlarged diameter, wherein the external face of the pole tube, in particular of the pole tube element 6, preferably extends to the tube part 4 and at least partially lies against the latter. The internal face of the lower region of the pole tube element 6 at least partially encloses a valve region 9 which will be explained in more detail in one of the following paragraphs. The pole tube 7 preferably has a clearance 18 which, for example, is formed in an annular manner on the circumference in the pole tube wall. Preferably, the clearance 18 is disposed so as to be coaxial with the coil 8 and in particular within the coil 8. By way of example, the clearance 18 has a quadrangular cross section.

Preferably, the pole tube element 6 of the pole tube 7 has a plurality of different internal diameters, each forming cylindrical spaces of different diameters. The pole tube 7 moreover has in particular a plurality of different external diameters. In the axial direction of the drive region 19, in the direction of the valve region 9, the pole tube 7 preferably has a first external diameter which forms the hollow cylinder 16 and preferably extends along the coil 8. Adjoining this is a second external diameter which is larger than the first external diameter, so that a step, in particular an axial end face, which points in the direction of the housing upper part 5 and against which the coil 8, by way of example, at least partially lies, is formed. The second external diameter is preferably smaller than the internal diameter of the tube part 4 and is in particular spaced apart therefrom in such a manner that a chamber 14 is formed between the pole tube 7 and the tube part 4. By way of example, the second external diameter is adjoined by a third external diameter of the pole tube 7, which is larger than the first and the second external diameter and preferably corresponds substantially to the internal diameter of the tube part 4, so that the pole tube 7 lies against the tube part 4 by way of the third external diameter. Formed between the second and the third external diameter is a step, in particular an axial end face, which points in the direction of the housing upper part 5. The pole tube element 6 is preferably formed from a magnetizable or magnetic material.

The chamber 14 is preferably designed for receiving a sealing element 13, in particular a sealing ring. Preferably, the chamber 14 is designed to be annular, and in particular has a rectangular cross section. The chamber 14 is in particular completely closed and delimited by the pole tube 7, the tube part 4 and, by way of example, the coil 8. The coil 8 preferably has a projection 15 which runs in the axial direction, in particular along the internal wall of the tube part 4, and extends between the tube part 4 and the pole tube 7 and is adjacent to the chamber 14. The projection 15 is preferably formed from a plastics material and in particular connected to the pole part 7 and the tube part 4 in a form-fitting manner. The end face of the projection 15 pointing in the valve direction preferably forms a delimitation of the chamber 14.

A sealing element 13 is attached in the chamber 14, wherein the sealing element 13 is preferably a sealing ring. By way of example, the sealing element 13 is designed to be annular and preferably has a round, in particular circular, cross section. Preferably, the sealing element 13 lies at least against the pole tube 7 and the tube part 4 and serves to seal the valve region 9 in relation to the drive region 19, so that no hydraulic fluid from the valve region 9 enters the coil 8. In particular, the sealing element 13 additionally lies against a step, preferably the axial end face formed between the second and the third external diameter of the pole tube 7.

Alternatively, it is possible that the projection 15 is designed as a support ring 15. By way of example, the support ring 15 is formed separately from the coil 8 and by way of an external face lies at least partially against the latter by way of an external face. The support ring 15 is preferably designed to be annular and, by way of example, has a rectangular cross section. In particular, the support ring lies against the inside of the tube part 4 by way of its external face, and lies against the external face of the pole tube 7 by way of its internal face. The end face of the support ring 15 pointing in the valve direction is adjacent to the chamber 14. The support ring 15 is preferably fixedly connected to the coil 8, the pole tube 7 and/or the tube part 4. Preferably, the support ring 15 forms a contact face for the sealing element 13.

The pole tube element 6 is preferably connected to the tube part 4 by way of a form-fitting connection. The form-fitting connection preferably comprises a radial clearance, in particular depressions, in the pole tube element 6, in which a radial constriction of the tube part 4 engages and interacts therewith in such a manner that the pole tube element 6 is fixed in the axial and the radial direction. The form-fitting connection is in particular a bayonet connection. For example, the pole tube 7, in particular the pole tube element 6, has a plurality of clearances 33 which are in particular designed to be hook-shaped. Each clearance 33 comprises, for example, a region extending in particular in the axial direction and, adjacent thereto, a region extending in the circumferential direction. At least one, or more, radial constriction(s) 32 of the tube part 4 preferably engages in the clearance 33. The clearances 33 are preferably radial depressions which are formed in the outer surface of the pole tube 7, which is adjacent to the tube part 4. Preferably, the clearances 33 extend into the chamber 14 and form in particular interruptions of the contact face of the sealing element 13. Only the regions of the clearance 33 that run in the circumferential direction are partially illustrated in FIG. 2.

The valve region 9 is preferably integrated in a hydraulic circuit, not shown, and fluidically connected to the vibration damper 2, in particular the working spaces of the vibration damper 2. The valve region 9 has an inflow 28 and an outflow 29, the functionality of which can be reversed as a function of the flow direction of the damping fluid.

The valve region 9 of the damping valve device 1 preferably comprises a control slide 17 which is at least partially or completely circumferentially enclosed by the pole tube element 6 and is disposed in particular so as to be coaxial with the latter and the tube part 4. The control slide 17 preferably has an axial end face which points in the direction of the armature 11 and against which the armature 11, in particular the lower, second region of the armature 11, lies in such a way that a movement of the armature 11 is transmitted to the control slide 17.

Furthermore, the valve region 9 comprises a valve block 27. The control slide 17 preferably circumferentially encloses the valve block 27 and is mounted so as to be movable in the axial direction relative to the valve block 27. The valve block 27 is in particular of a funnel-shaped design and, by way of example, has an upper cylindrical region which faces the drive unit 19 and is disposed so as be coaxial with the control slide 17. On the lower region facing away from the drive unit 19, the valve block 27, by way of example, has a radial enlargement. The valve block 27 is in particular attached so as to be stationary relative to the axially movable control slide 17.

Preferably, the valve block 27 is circumferentially and in the axial direction at least partially or completely enclosed by the pole tube element 6, wherein the control slide 17 is disposed between the upper region of the valve block 27 and the pole tube element 6. The lower region of the valve block 27 is disposed in the radial direction so as to be directly adjacent to the pole tube element 6, and preferably at least partially lies against the latter. Formed within the valve block 27 are only partially illustrated passage opening and/or flow passages 20, through which the damping fluid is able to flow from the inlet 28 in the direction of the outlet 29. The control slide 17 is attached so as to be axially movable in such a manner that it completely releases the flow passages 20 in an opened position of the damping valve device 1, and completely closes the flow passages 20 in a closed position of the damping valve device 1. The control slide 17 can preferably assume a plurality of intermediate positions in which the flow passages 20 are partially closed. The control slide 17 is preferably preloaded in the direction of an opened valve position by means of a spring, not illustrated, so that the damping valve is opened in the case of a non-energized coil 8. The spring is preferably disposed between the control slide 17 and the valve block 27 and impinges the control slide preferably with a force acting axially in the direction of the drive region 19. Formed between the valve block 27 and the pole tube element 6 is preferably an annular gap 30 for conducting the damping fluid. The annular gap 30 preferably extends completely about the upper region of the valve block 27 that is able to be enclosed by the control slide 17, and extends in particular at least partially or completely about the lower region of the valve block 27. Preferably, the control slide 17 is axially movable within the annular gap 30.

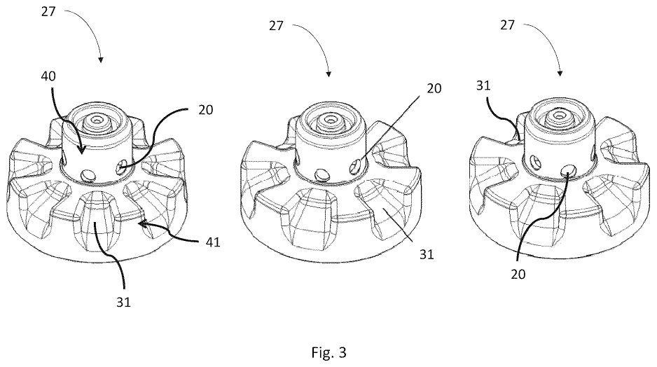

The valve region 9 preferably comprises a comfort valve and a solenoid valve, which are hydraulically connected in series with one other. By way of example, the valve block 27 comprises two valve bodies. The valve body facing in the direction of the drive region is, for example, the solenoid valve body which is illustrated in FIG. 3 and preferably has the previously described flow passages 20 and a plurality of flow ducts 31 and interacts with the control slide 17 movable by means of the coil 8. In the direction of the cylinder tube 21 of the vibration damper 2, a comfort valve body which is not illustrated in FIG. 3 preferably adjoins the solenoid valve body. By way of example, the valve block 27, which is optionally formed from the solenoid valve body and the comfort valve body, is designed in one part or one piece.

The fluid outflow 29 is in particular formed between the valve block 27 and the pole tube 7. A plurality of flow ducts 31 are preferably formed between the pole tube 7 and the valve block 27.

The flow ducts 31 are at least partially formed in the valve block 27. The flow ducts 31 preferably extend along the pole tube 7, wherein the pole tube 7 preferably has no passage openings, in particular bores, for conducting the damping fluid through the pole tube wall.

By way of example, the pole tube 7 extends at least partially in the axial direction along the comfort valve body. The end region of the pole tube 7 is preferably mechanically formed so as to form a connection between the pole tube 7 and the valve block 27. The pole tube 7 and the valve block 27 are connected to one other in particular by means of a mechanical joining connection. For example, the joining connection is a crimp or a bead roll. Preferably, the end region of the pole tube 7 pointing in the direction of the comfort valve is formed radially inward, so that a forming edge of the pole tube 7 that points radially inward is in particular formed.

FIG. 3 shows a detailed view of the valve block 27 in three exemplary embodiments, wherein the valve block 27 corresponds to that of FIG. 2, apart from the differences described below.

The valve block 27, in particular the solenoid valve body, has a first cylindrical region 40, in which the flow passages 20 are formed. The first region 40 is preferably adjoined in the direction of the fluid outlet 29 by a second substantially cylindrical region 41 with a larger diameter relative to the first region 40. The flow ducts 31 are formed in the second region. The flow ducts 31 are preferably designed to be open in the direction of the pole tube 7 which is not illustrated in FIG. 3, so that the flow ducts 31 are in each case formed between the inner surface of the pole tube 7 and the radially outward-pointing face of the valve block 27, in particular of the second region 41. By way of example, the second region 41 has a radially outward-pointing circumferential face and a shoulder face which points axially in the direction of the first region 40. The shoulder face preferably lies against the pole tube 7. The flow ducts 31 preferably extend from the shoulder face to the circumferential face and in particular represent clearances, preferably convexities, in the shoulder face and the circumferential face. By way of example, the direction of extent of the flow ducts 31 has an axial and a radial component. For example, the flow ducts 31 extend continuously at an angle of 10° to 80°, in particular 20° to 60°, preferably 30° to 50°, in relation to the axial direction. By way of example, the flow ducts 31 are formed as half-shell shapes in the valve block 27 and extend in particular in a star shaped manner away from the first region 40, in particular from the flow passages 20. By way of example, the flow ducts 31 extend in each case from a radially inner, completely circular region of the shoulder face outward to the circumferential face. The flow ducts 31, for example, have a round, semicircular, circular, oval, rectangular or square cross section. Preferably, all or a plurality of flow ducts 31 are of a geometrically identical design and in particular uniformly spaced apart from one another in the circumferential direction.

The first region 40 of the valve block 27 has the flow passages 20 and is preferably disposed so as to be coaxial with the control slide 17 which is not illustrated in FIG. 3. The first region 40 is preferably able to be completely or partially enclosed by the control slide 17. The flow passages 20 are preferably circular bores in the valve block 27, in particular the wall of the first region 40 of the valve block 27. By way of example, the flow passages 20 are disposed so as to be uniformly spaced apart from one another. Preferably, the valve block 27 has six flow passages 20 which are disposed circumferentially about the first region 40 of the valve block 27, and mutually adjacent flow passages 20 are in particular disposed so as to be mutually offset by 60°. The number of flow passages 20 is preferably an even number, in particular four, six, eight or ten.

The left-hand exemplary embodiment of FIG. 3 shows a valve block having six flow passages 20, wherein at least one flow passage 20 is disposed so as to be offset with respect to the radial extent of the adjacent flow duct 31. By way of example, three flow passages 20 are disposed so as to be offset with respect to the respective adjacent flow duct 31, wherein three flow passages 20 are each disposed so as to be co-aligned with a flow duct 31. By way of example, the number of flow ducts 31 is greater than the number of flow passages 20. By way of example, eight flow ducts 31 are provided.

By way of example, in the central exemplary embodiment of FIG. 3, all flow passages 20 are disposed so as to be co-aligned with a respective flow duct 31. By way of example, the number of flow ducts 31 corresponds to the number of flow passages 20.

By way of example, in the right-hand exemplary embodiment of FIG. 3, all flow passages 20 are disposed so as to be offset with respect to the radial extent of the respective adjacent flow duct 31.

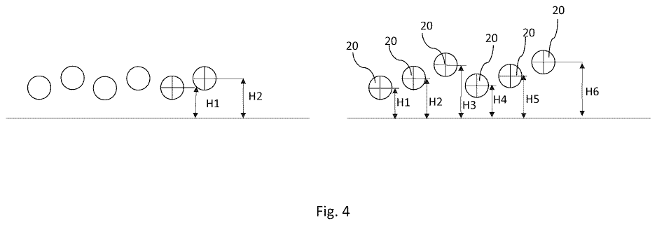

FIG. 4 illustrates two examples of a disposal of the flow passages 20 in the valve block 27, in particular in the first region 40 of the valve block 27, in a 2D view. By way of example, the flow passages have a circular cross section, wherein all flow passages 20 have the same diameter.

It is likewise conceivable that at least two, a plurality of or all flow passages 20 have different diameters and/or geometries.

In the left-hand exemplary embodiment of FIG. 4, the flow passages 20 are disposed at different height levels. For example, in FIG. 4, in each case three flow passages 20 are disposed at a first height level H1 and in each case three flow passages 20 are disposed at a second height level H2. For example, directly adjacent flow passages 20 are disposed at different height levels, wherein preferably every second flow passage 20 is disposed at the same height level. The height level is preferably understood to mean the spacing of the center of the respective flow passage 20 from a cross-sectional plane. This is understood to mean in particular the axial spacing of the center of the respective flow passage 20 from the shoulder face of the valve block 27.

In the right-hand exemplary embodiment of FIG. 4, all flow passages 20a-f are disposed at different height levels H1 to H6. The height levels H1 to H6 illustrated in the right-hand exemplary embodiment are in ascending order H1, H4, H2, H5, H3, H6, wherein H1 is the lowest height level and H6 is the highest height level. Preferably, the flow passages 20a and 20d, and 20b and 20e, and 20c and 20f are disposed so as to be opposite, mutually offset by 180°. Preferably, flow passages 20a-f which are circumferentially opposite one another on the valve block 27 have a height level difference that is less than the height level difference in relation to the respective directly adjacent flow passages 20a-f.

Optionally, flow passages 20a-f which are circumferentially opposite one another on the valve block 27 are disposed at the same height level H1 to H6 so that the height levels are disposed so that H1 is the same as H4, H2 is the same as H5 and H3 is the same as H6.

The damping valve device 1 serves in particular to continuously adjust the damping of the vibration damper 2. In the operation of the vibration damper 2, the coil 8 is impinged with electrical current to set the desired damping. A magnetic field is generated as a result, the magnetic field lines of which run substantially in the axial direction in the coil interior and in particular in the armature space 26. The magnetic flux of the magnetic field runs in a magnetic circuit which is formed within the damping valve device 1. The magnetic circuit comprises components made of materials with a low magnetic resistance, preferably of magnetic or magnetizable material. The magnetic circuit for conducting the magnetic field, in particular the magnetic flux, is preferably formed from the flux plate 10, the hollow cylinder 16, the pole tube element 6, the armature 11, the tube part 4 and/or the pole part 12. The armature 11 is moved in the axial direction, corresponding to the polarity of the magnetic field. The movement of the armature 11 is transmitted to the control slide 17 which is coupled to the armature 11, so that said control slide 17 closes the flow passages 20 of the valve block 27 or at least partially releases them. Shown by way of example in FIG. 2 is an opened position of the damping valve device 1.

### LIST OF REFERENCE SIGNS

1 Damping valve device
2 Vibration damper
3 Damping valve housing
4 Tube part
5 Housing upper part
6 Pole tube element
7 Pole tube
8 Coil
9 Valve region
10 Flux plate
11 Armature
12 Pole part
13 Sealing element
14 Chamber
15 Projection/support ring
16 Hollow cylinder
17 Control slide
18 Recess
19 Drive unit
20a-f Flow passages
21 Cylinder tube
22 Cover portion
23 Hollow cylinder portion/receptacle
24 Form-fitting connection
25 Connecting region
26 Armature space
27 Valve block
28 Inflow/fluid inlet
29 Outflow/fluid outlet
30 Annular gap
31 Flow ducts
32 Constriction
33 Clearance in the pole tube
40 First region
41 Second region
H1: First height level
H2: Second height level
H3: Third height level
H4: Fourth height level
H5: Fifth height level
H6: Sixth height level

1-11. (canceled)

12. A damping valve device for a hydraulic vibration damper for a vehicle, comprising:
a drive region and a valve region; and
a damping valve housing having a tube part which encloses the drive region and the valve region;
wherein the drive region has a coil which is designed in such a manner that it generates a magnetic circuit within the damping valve device and interacts with an armature that is attached so as to be axially movable within the coil, in order to move the armature in the axial direction;
wherein the armature is disposed within a pole tube, and the pole tube forms a guide of the armature;
wherein the valve region has a fluid inlet and a fluid outlet for letting a hydraulic fluid into and out of the valve region, and a valve block having a plurality of flow passages for conducting the hydraulic fluid;
wherein the valve region has a control slide which is attached so as to be movable relative to the valve block in such a manner that it is movable between a closed position in which the flow passages are closed by the control slide and an opened position in which the flow passages are free;
wherein at least two flow passages are disposed at different height levels, wherein at least one flow duct is disposed so as to be offset with respect to the flow passages.

13. The damping valve device as claimed in claim 12, wherein at least two flow passages are disposed at the same height level.

14. The damping valve device as claimed in claim 12, wherein flow passages which are circumferentially opposite one another on the valve block are disposed at the same height level.

15. The damping valve device as claimed in claim 12, wherein flow passages which are circumferentially opposite one another on the valve block have a height level difference that is less than the height level difference in relation to the respective directly adjacent flow passages.

16. The damping valve device as claimed in claim 12, wherein at least two flow passages have different diameters.

17. The damping valve device as claimed in claim 12, wherein at least two flow passages have different geometries.

18. The damping valve device as claimed in claim 12, wherein a plurality of flow ducts which extend at least partially in the radial direction are formed between the pole tube and the valve block.

19. The damping valve device as claimed in claim 18, wherein at least one flow duct is disposed so as to be co-aligned with one of the flow passages.

20. The damping valve device as claimed in claim 12, wherein the pole tube extends in the axial direction beyond the valve block.

21. The damping valve device as claimed in claim 12, wherein the damping valve housing has a housing upper part which is attached to the end face of one end of the tube part, and wherein the pole tube extends from the housing upper part to the valve block.

22. A vibration damper for a vehicle, comprising a damping valve device as claimed in claim 12, wherein the vibration damper has an outer cylinder tube, and wherein the tube part of the damping valve device is connected to the cylinder tube.
